(19) United States
(12) Patent Application Publication
(10) Pub. No.: US 2018/0287799 A1
(43) Pub. Date: Oct. 4, 2018

(54) A METHOD OF TRANSMITTING DATA, A MOBILE ELECTRONIC DEVICE, AN ELECTRONIC TOKEN, A SOFTWARE SERVICES PLATFORM AND A COMPUTER PROGRAM PRODUCT

(71) Applicant: Erik Jan Harkes, Almere (NL)

(72) Inventor: Erik Jan Harkes, Almere (NL)

(21) Appl. No.: 15/526,666

(22) PCT Filed: Nov. 12, 2015
(86) PCT No.: PCT/NL2015/050795

§ 371 Date: May 12, 2017

(30) Foreign Application Priority Data
Nov. 12, 2014 (NL) 2013781

(51) Int. Cl. H04L 9/32; H04W 12/04; H04W 4/80; H04W 12/06

(52) U.S. Cl. CPC H04L 9/3213; H04W 12/04; G06K 7/10366; H04W 12/06; H04L 2209/805; H04W 4/80

(57) ABSTRACT

The invention relates to a method of transmitting data from a software services platform to an electronic token. The method comprises the steps of pushing or pulling encrypted data from the platform via the Internet to a mobile electronic device, providing a short range wireless communication channel between the mobile electronic device and the electronic token, and forwarding the encrypted data from the mobile electronic device towards the electronic token.

The invention relates to a method of transmitting data.

Air plane passengers have to take care of a lot documents when passing check points in airports. Travel documents are paper based and include boarding passes, bag tags, baggage claims and vouchers. Apart form the waste of paper material, printed documents are awkward to manage, especially if the passenger has to take care of other properties such as suitcases etc.

It is an object of the invention to provide a convenient and secure method for processing travel data. Thereto, according to an aspect of the invention, a method is provided of transmitting data from a software services platform to an electronic token, comprising the steps of pushing or pulling encrypted data from the platform via the Internet to a mobile electronic device, providing a short range wireless communication channel between the mobile electronic device and the electronic token, and forwarding the encrypted data from the mobile electronic device towards the electronic token.

By transmitting travel data in encrypted format from a software services platform via a mobile electronic device to an electronic token, relevant travel information can be provided in an easy and secure way. By applying Internet functionality encrypted data can easily be sent to a mobile electronic device having Internet connectivity such as a smartphone. The electronic token can e.g. be implemented as a smartcard, e.g. for displaying a boarding pass image, or as a bag tag, e.g. for displaying a bag tag image. By forwarding the encrypted data via a short range wireless communication channel to the electronic token, an active connection is not required because of which the electronic token less power demanding and may include cheaper components, thereby rendering the method even more attractive for passengers.

Preferably, the electronic token comprises a secure element for decrypting the received encrypted data received from a software services platform. By decrypting the encrypted data on the electronic token, there is no strict requirement that the mobile electronic device is secure. In principle, the data that is available on the mobile electronic device is encrypted and therefore meaningless for devices and/or persons having access unintentionally and/or unauthorized access to data on the mobile electronic device. Therefore, the claimed two-step transmission method inherently provides a secure end-to-end data transmission for passengers thus eliminating the need of paper travel documents while providing a fast, convenient and secure way to pass through airports.

Advantageously, the method may further comprise a step of performing an authentication and/or authorization process between the platform and the electronic token, via the mobile electronic device, thereby enhancing the security of the data transmission.

The invention also relates to a mobile electronic device, an electronic token and a software services platform.

Further, the invention relates to a computer program product. A computer program product may comprise a set of computer executable instructions stored on a data carrier, such as but not limited to a flash memory, a CD or a DVD. The set of computer executable instructions, which allow a programmable computer to carry out the method as defined above, may also be available for downloading from a remote server, for example via the Internet, e.g. as an app.

Other advantageous embodiments according to the invention are described in the following claims

By way of example only, embodiments of the present invention will now be described with reference to the accompanying figures in which

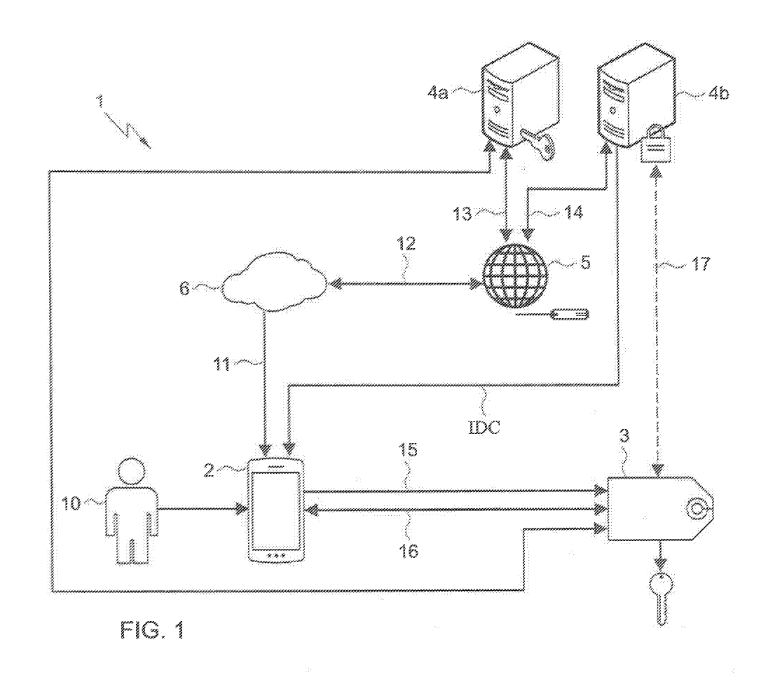

FIG. 1 shows an overview of a data exchange system including a mobile electronic device, an electronic token and a software services platform according to the invention;

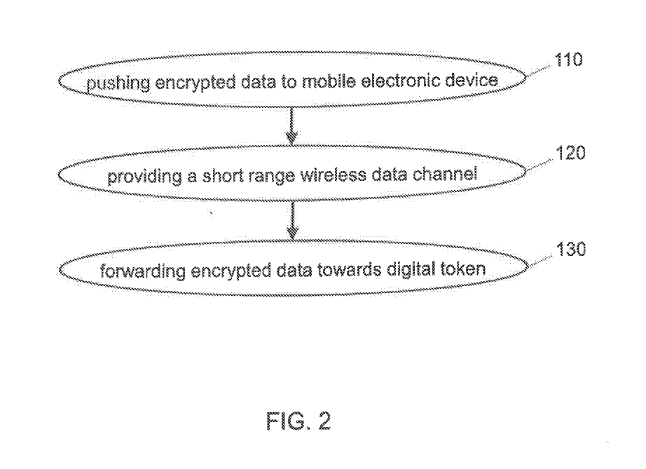

FIG. 2 shows a flow chart of a first embodiment of a method according to the invention;

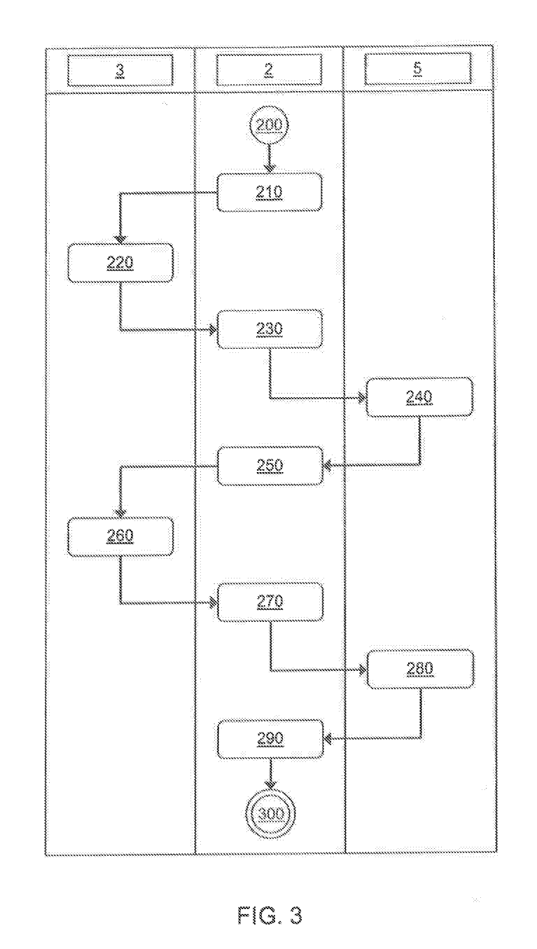

FIG. 3 shows a flow chart of a second embodiment of a method according to the invention;

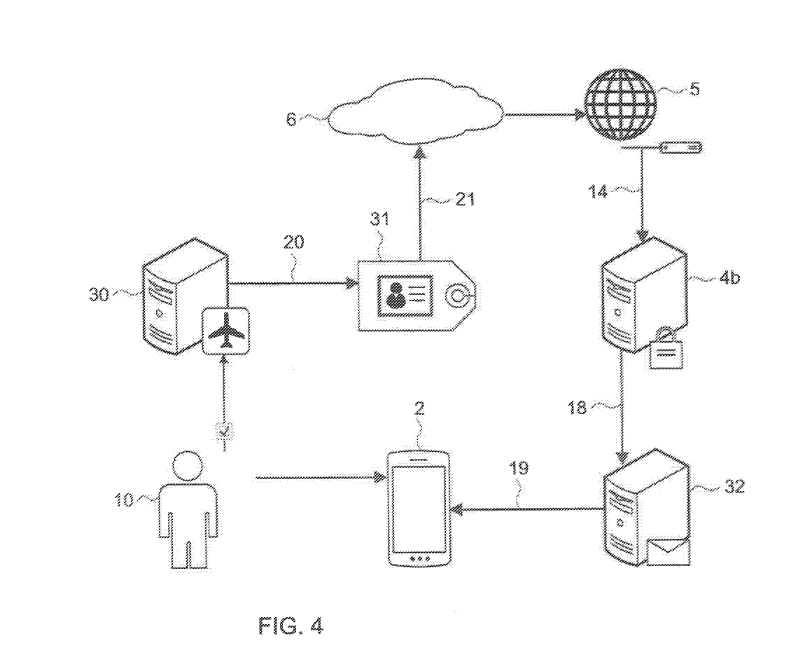

FIG. 4 shows a data flow to the mobile electronic device;

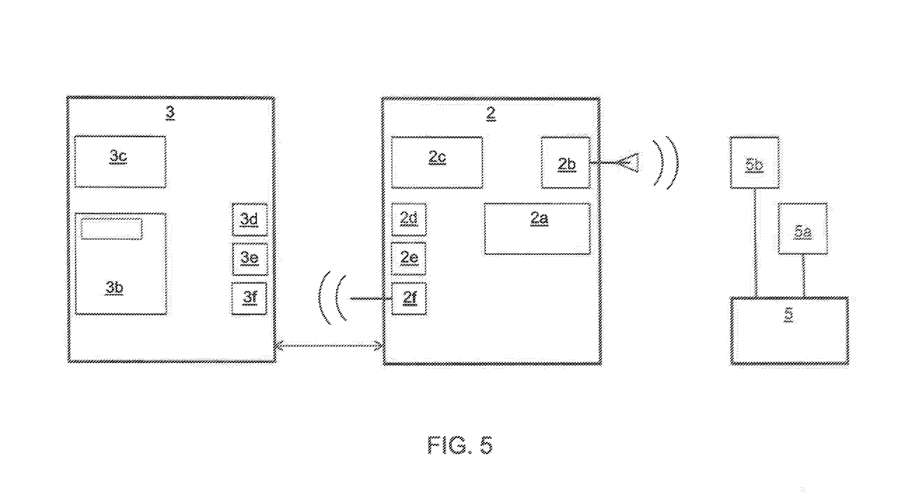

FIG. 5 shows another overview of the data exchange system;

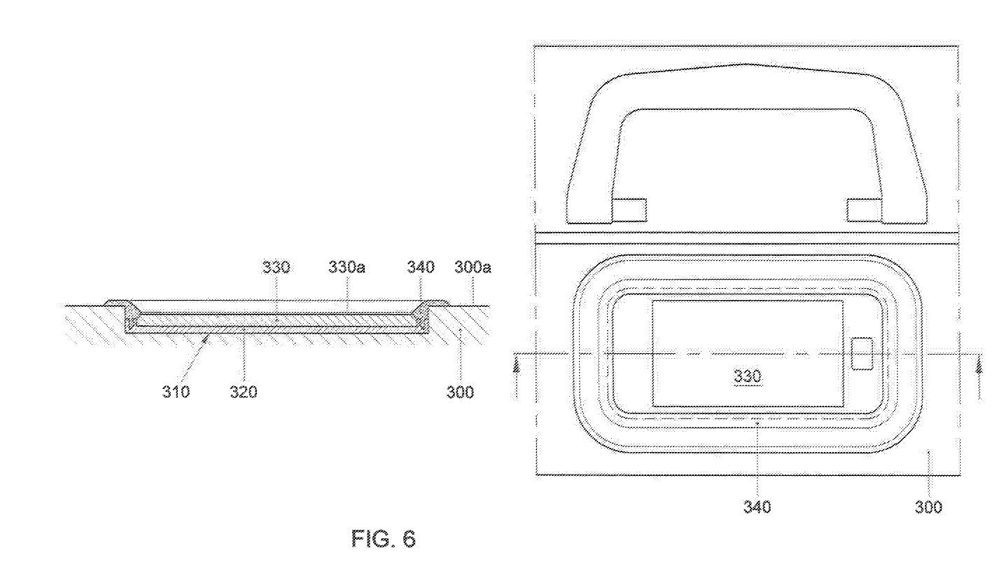

FIG. 6 shows a first embodiment of an electronic token according to the invention;

FIG. 7 shows a second embodiment of an electronic token according to the invention;

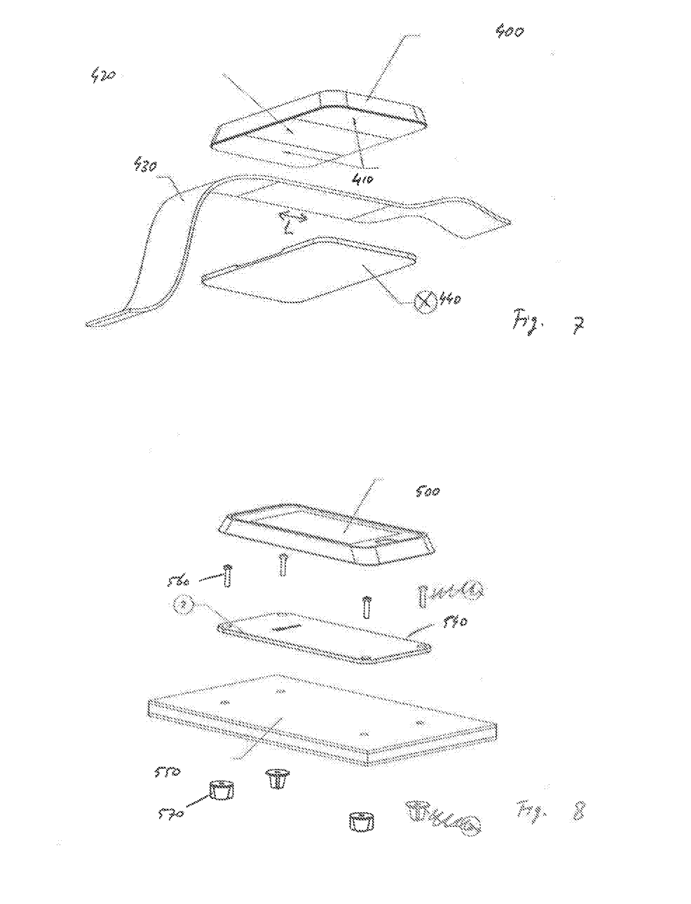

FIG. 8 shows a third embodiment of an electronic token according to the invention;

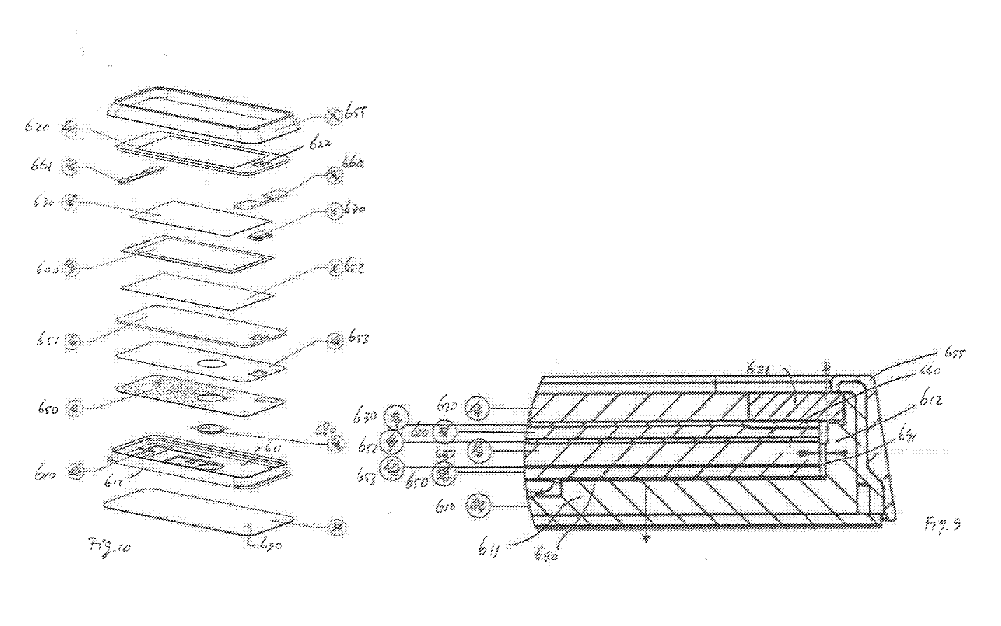

FIG. 9 shows a fourth embodiment of an electronic token according to the invention, and

FIG. 10 shows an exploded view of the electronic token depicted in FIG. 9.

The figures merely illustrate preferred embodiment according to the invention. In the figures, the same reference numbers refer to equal or corresponding parts.

FIG. 1 shows an overview of a data exchange system 1 including a mobile electronic device 2, an electronic token 3 and a software services platform 5 according to the invention. The mobile electronic device 2 and the software services platform 5 may communicate via the Internet 6 and at least one Internet connection 11-14. On the other hand, the mobile electronic device 2 and the electronic token 3 may communicate via a short range wireless connection 16, e.g. based on NFC, BT, BLE or RFID UHF technology.

Preferably, the short range wireless connection 16 can be switched on and off, e.g. via a manual switch or an electronic switch.

The encrypted data may include travel information to support and facilitate efficient and reliable transport of persons and luggage, e.g. at intensive traffic points such as airports, for check-in, handling and check-out processes.

The mobile electronic device 2 has Internet connectivity and comprises a processor that is arranged for performing dedicated tasks supporting exchange of data. Said tasks include receiving encrypted data from the software services platform 5, providing a short range wireless communication channel 15 between the mobile electronic device 2 and an electronic token 3, and forwarding the encrypted data from the mobile electronic device 2 towards the electronic token 3, as explained in more detail below.

The mobile electronic device 2 can be implemented as a smartphone, tablet or other portable device. Also other implementations are possible such as a laptop or a smart watch.

The electronic token 3 also comprises a processor for performing dedicated tasks supporting exchange of data. Said tasks include supporting the short range wireless communication channel 5 with the mobile electronic device 2 that has received encrypted data from the software services platform 4, and

receiving the encrypted data from the mobile electronic device 2.

The electronic token 3 can be implemented as a bag tag, a smartcard or another personalized electronic item.

The software services platform 5 comprises an encrypted data database 4b including encrypted data, and a processor for pushing or pulling encrypted data from the platform 5 via the Internet 6 to the mobile electronic device 2.

In the shown embodiment, the software services platform 5 comprises an electronic token database 4a including a list of electronic tokens, wherein each of the electronic tokens is associated with a private key and authentication data.

In a specific embodiment, the processor, the encrypted data database 4b and/or the electronic token database 4a are integrated in a single server. Alternatively, at least one of said components is implemented in a separate hardware module and data is exchanged via secure data channels 13, 14.

FIG. 2 shows a flow chart of an embodiment of a method according to the invention. The method is used for transmitting data from a software services platform to an electronic token. The method comprises a step of pushing or pulling 110 encrypted data from the platform via the Internet to a mobile electronic device, a step of providing 120 a short range wireless communication channel between the mobile electronic device and the electronic token, and a step of forwarding 130 the encrypted data from the mobile electronic device towards the electronic token.

The encrypted data may include travel information, e.g. information for generating and displaying boarding pass data or electronic bag tag data, preferably in a format that is downward compatible with presently used hardcopy boarding passes and bag tags, respectively.

During the pushing or pulling step 110 encrypted data is sent from the encrypted data database 4b of the platform 5, via an Internet data channel IDC including the Internet 6 and Internet connections 11, 12, 14 to the mobile electronic device 2. Then, a short range wireless communication channel 15 is provided between the mobile electronic device 2 and the electronic token 3.

Further, the encrypted data are forwarded from the mobile electronic device 2 to the electronic token 3, via said short range wireless communication channel 15.

Advantageously, the method also includes a step of performing an authentication and/or authentication process between the platform 5 and the electronic token 4, via the Internet 6, the mobile electronic device 2 and the short range wireless connection 16. Then, the security of the data channel end points can be verified. In a specific embodiment, the step of pushing or pulling the encrypted data to the mobile electronic device 2 and/or the step of forwarding the encrypted data towards the electronic token 3 is only performed if the authentication process has a positive result. In addition, information can be sent to the mobile electronic device 2 that the authentication process failed, in order to inform the user thereof.

Optionally, the platform 5 further transmits user interface information to the mobile electronic device 2, e.g. display data for generating a preview of the data to be displayed on the electronic token 3.

The step of providing a short range wireless communication channel 15 may include the substep of checking whether the electronic token 3 can be reached from the mobile electronic device 2, via the short range wireless connection 16. If the short range wireless connection 16 is active, a short range wireless communication channel 15 can be set up and maintained, at least for the time period of forwarding the encrypted data. If the short range wireless connection 16 is inactive, the mobile electronic device 2 may attempt to active said wireless connection 16 to proceed with setting up the short range wireless communication channel 15. If the mobile electronic device 2 fails in setting up the short range wireless connection 16, new attempts can periodically be performed. Further, the mobile electronic device 2 may inform the platform 5 that the encrypted data have not reached the electronic token 3, so far.

Preferably, the electronic token 3 comprises a secure element for decrypting the encrypted data, so that meaningful information can be retrieved from the encrypted, e.g. for the purpose of displaying information such as a boarding pass image or a bag tag image, both optionally including optical security data such as one-dimensional and/or multi-dimensional optical code, e.g. a barcode or a QR code.

The secure element may be used for performing the authentication process and/or for decrypting the encrypted data. Thereto, the secure element may comprise a private hardware key and/or a decryption controller. The decryption controller can be integrated with the processor that supports the short range wireless communication channel. Alternatively, the decryption controller is a separate hardware module. The encryption/decryption process may e.g. be implemented using a single, private key, e.g. using an AES algorithm, or using a private key and a public key e.g. using an RSA algorithm. By decrypting the encrypted data on the electronic token 3, a secure end-to-end transmission can be obtained.

Preferably, the electronic token 3 comprises a display for displaying boarding pass data and/or electronic bag tag data, from the received from the mobile electronic device 2. In a highly preferred embodiment, the display includes an E-paper display so that information can be displayed with a minimum of energy or even no energy.

In a practical embodiment wherein the electronic token 3 is implemented as a bag tag, the token 3 is permanently or semi-permanently mounted to a luggage device, so that luggage associated with the encrypted data for the electronic token 3 is mechanically connected to the token 3 carrying said encrypted data.

In a specific embodiment, the electronic token 3 comprises a basic module including all the hardware providing the electronic functionality, and a removable intermediate module that is connectable to a luggage device. As an example, the intermediate module is designed as a frame having standard inner dimensions for receiving the basic module and dedicated outer dimensions for fitting on a specific luggage device such as a suitcase. Then, the basic module is exchangeable and a single basic module can easily be connected to a variety of luggage devices. The basic module can be connected to the intermediate module using a connection technique, e.g. a snapping connection optionally provided with a releasable securing element such as a spring activated tag release trigger. The intermediate module can be connected to the luggage device using a screw connection and/or a glue connection and/or in combination with a luggage strap. Optionally, the intermediate module includes a cavity for receiving the basic module for protecting against damage. Also, the intermediate module can be provided with a frame including shock absorbing material to decrease any chance that the basic module is mechanically damaged, e.g. during transport or storage of the luggage device.

Preferably, the electronic token 3 is mounted in a cavity of the luggage device thereby counteracting damage to the electronic token 3. Then, the intermediate module can be mounted in the cavity in a permanent or semi-permanent manner, e.g. using a screw connection and/or a glue connection. The intermediate module can even be built in or integrated in the luggage device or suitcase, preferably at a flat or even exterior surface of the luggage device or suitcase. Alternatively, the electronic token 3 is mounted on a flat outer surface of the luggage device, or the electronic token 3 is connected to a strap of the luggage device. Further, the electronic token 3 can be mounted at a side of the luggage device that is provided with a handle to optimize visibility of the token 3. Optionally, the electronic token 3 also includes a top part at least covering a part of the basic module. Then, the basic module is sandwiched between the intermediate module and the top part.

Advantageously, a front side of the basic module is at a retracted position with respect to the exterior surface of the luggage device or suitcase, thereby protecting the display of the tag and the tag itself.

In a specific embodiment, the electronic token 3 further comprises a localization system and/or a transmitter for transmitting data to a further, preferably longer range, wireless communication channel 17, see e.g. FIG. 1. As an example, the localization system may include assisted GPS or A-GPS. Further, the transmitter may use GPRS to transmit data to the platform 5. Then, a track and trace functionality can be offered.

In addition, the electronic token 3 may comprise a user interface for receiving user-specific data, e.g. for the purpose receiving a PIN code and/or biometric data. Then, additional authentication processes can be performed between the platform 5 and the electronic token 3.

The method of transmitting data from a software services platform 5 to an electronic token 3 can be performed using dedicated hardware structures, such as FPGA and/or ASIC components. Otherwise, the method can also at least partially be performed using a computer program product comprising instructions for causing a processor of a computer system or a control unit to perform the above described steps of the method according to the invention, or at least the step of performing authentication steps. All (sub)steps in either the web-based platform 5, the electronic device 2 or the electronic token 3 can in principle be performed on a single processor. However, it is noted that at least one step can be performed on a separate processor. A processor can be loaded with a specific software module. Dedicated software modules can be provided, e.g. from the Internet.

It is noted that the electronic token database 4a of the platform 5 includes a list of unique electronic tokens associated with users of said tokens. A specific user may be associated with one or more electronic tokens. It is further noted that the method of transmitting data from a software services platform to an electronic token can not only be applied for processing air travel documents, but also for other applications, such as processing seaport travel documents of sea containers or other transport goods. Further, the electronic token implemented as smartcard can be applied for authorizing bank transactions, for having pre-paid travel document functionality for private or public transport, and/or for providing access to ports and restricted areas. Here, a secure end-to-end transmission is obtained since the electronic token is a secure end device receiving encrypted data that is received from a software services platform, via a mobile electronic device that might be less secure.

FIG. 3 shows a flow chart of a second embodiment of a method according to the invention. Here, three columns are shown, e.g. referring to the electronic token 3, the mobile electronic device 2 and the software services platform 5, also called the backend. A process of uploading travel documents starts from a beginning state 200. Here, operations are displayed in a specific column to indicate a device or platform involved therewith. Starting from the beginning state 200, a mobile electronic device 2 initiates a step 210 of secure uploading travel documents in a secure way, e.g. from an airline platform to the software services platform 5. To that end, a secure connection between the electronic token 3 and the software services platform 5 is established in a subsequent step 220. Then, it is requested via the electronic device 2, in a next step 230, that a travel information document from the software services platform is delivered to the electronic token 3. Said travel information document is encrypted at the platform, in an encrypting step 240 and transmitted to the electronic token 3, via the electronic device 2, in a transmitting step 250. At the electronic token 3, the travel information document is received, verified and displayed in a next step 260. Then, verification data is transmitted, in a transmission step 270, from the electronic token 3, via the electronic device 2, to the platform 5, for verification the token response at the software services platform 5, in a verification step 280. As a next step 290, the platform informs the electronic device 2 that the secure upload of the travel document has successfully finished, ending in a final phase 30.

FIG. 4 shows a data flow to the mobile electronic device 2. Here, a passenger user operating the mobile electronic device 2 enters into an airline platform 30 to verify flight data and to check in for a flight. The user may do this e.g. via an online Internet application, via a check in device in an airport or via an app installed on the mobile electronic device 2.

If the check-in process is successful, the airline platform 30 uploads the associated flight data 31 via an Internet connection 20, 21 to the software services platform 6 described above that is supported in the Internet. The flight data is encrypted and stored in the encrypted data database 4b described above referring to a specific personal account of the user. Then, notification data 32 is sent to the mobile electronic device 2 using Internet connections 18, 19 to inform the user that flight data is ready to be transmitted in encrypted form towards the electronic token 3. The user is then able to transmit relevant flight data (travel documents) from the encrypted database 4b towards the electronic token 3 associated with the person account of the user, using the mobile electronic device 2 and the process described referring to FIGS. 1 and 2.

FIG. 5 shows another overview of the data exchange system 1 including the mobile electronic device 2, the electronic token 3 and the software services platform 5, also called back-end. The platform 5 has a cellular data network connectivity 5a, and a WIFI connectivity point 5b. Also the mobile electronic device 2 is provided with a cellular data network connectivity 2a, and a WIFI connectivity point 2b so that the platform 5 and the electronic device 2 may mutually communicate. Further, both the electronic mobile device 2 and the electronic token 3 are provided with an application processor 2c, 3c and short range wireless communication units 2d-f, 3d-f or a selection of such units, to facilitate short range wireless communication between the electronic token 3 and the electronic device 2. In the shown embodiment, the electronic token 3 includes a secure element 3b for decrypting encrypted data received from the platform 5, via the electronic device 2.

FIG. 6 shows a first embodiment of an electronic token 2 according to the invention as described above. The left-hand side of the figure shows a cross sectional view and the right-hand side of the figure shows a top view of the token, in assembled state with a suitcase 300 provided with an cavity 310. The token includes the intermediate module 320 located at the bottom of the cavity 310. On top of the intermediate module 320, the basic module 330 is placed. Further, on top of the basic module 330, at top edges thereof, a top module 340 is located securing the basic module 330 in the cavity 310 of the suitcase. The exterior surface 330a of the basic module facing outwardly is located in a retracted position relative to the outer surface 300a of the suitcase 300.

FIG. 7 shows a second embodiment of an electronic token according to the invention. Here a basic module 400 is provided with an adhesive layer 410, 420 that may be implemented as double sided tape. In the shown embodiment, the adhesive layer includes three mainly rectangular sections, viz. two end sections 410 and a central section 420. The adhesive layer may be covered by a top liner that can be removed to expose the adhesive material at the surface facing away from the basic module 400 so as to attach said module to another object. Preferably, each section 410, 420 of the adhesive layer is provided with a corresponding top liner. As a first option, the basic module 400 is attached to a luggage device using the adhesive layer. As an example, the top liners of all adhesive layer sections 410, 420 are removed.

Alternatively, the top liner of the two adhesive layer end sections 410 are peeled off so that the end sections connect the basic module 400 to the luggage device. As a second option, the electronic token includes an adapter plate 440. Now, the basic module 400 is attached to said adapter plate 440 using the adhesive layer of the end sections 410, sandwiching a bag belt or strap 430 therebetween. As the central section 420 of the adhesive layer is still covered by its top liner, the assembly of the basic module 400 and the adapter plate 440 may be shifted along the longitudinal axis L of the bag belt or strap 430. It is noted that the adhesive layer may include more or less than three sections, e.g. one or two sections or four or five sections. Also, another geometry of the adhesive layer sections can be chosen.

FIG. 8 shows a third embodiment of an electronic token according to the invention. Again, the token includes a basic module 500 and an adapter plate 550. Here, the adapter plate 550 is attached to a suitcase device using mechanical connections. In the shown embodiment, four bolt and nut pairs 560, 570 are used for fixing the plate 550 to an exterior wall of the luggage device, e.g. a suitcase having a fabric exterior surface. Then, the basic module 500 may be attached to the adapter plate 550 using an adhesive layer, as described above referring to the adhesive layer 410, 420 applied in the embodiment shown in FIG. 7.

FIG. 9 shows a fourth embodiment of an electronic token according to the invention. The token includes a basic module 600, an intermediate module 610 and a shock absorbing module 620. The intermediate module 610 forms a frame having a floor section 611 and a wall section 612 extending transverse from the floor section 611. The intermediate module 610 is to be attached to a luggage device and accommodates a layer structure including the basic module 610 and the shock absorbing module 620. The wall section 612 of the intermediate module 610 supports the shock absorbing module 620, while the intermediate module 610 carries the basic module 600. The basic module 600 is attached to the shock absorbing module 620, in the shown embodiment via an optical bonding layer 630, such that the basic module 600 is located between the shock absorbing module 620 and the floor section 611 of the intermediate module 610. By arranging the structure of the token such that the basic module 600 including the display is freely movable, or at least has some play, preferably in a direction transverse to the floor section 611 and optionally also along said floor section, a risk of damaging the basic module 600 is minimized, e.g. when the token is subjected to an external impact force. Then, any tensile stress in the display of the basic module 600 is counteract or even avoided. that tensile stress In the shown embodiment, a first airgap 640 is provided between the floor section 611 and a sandwich layer including the basic module 600, and a second airgap 641 is provided between the wall section 612 of the intermediate module 610 and said sandwich layer including the basic module 600. In the shown embodiment, the sandwich layer further includes a PCB layer 650 including electronic components and a reinforcement PCB layer 651 attached to a bottom layer of the basic module 600 via a bonding layer 652 and a double sided tape 653. Further, the token includes a bumper 655 serving as a casing covering the wall section 612 of the intermediate module 610 and clamping an edge portion 621 of the shock absorbing module 620 to said wall section 612, thereby mounting the sandwich layer including the basic module 600 to the intermediate module 610.

Advantageously, the shock absorbing module 620 is transparent and includes shock absorbing material such as polycarbonate. External impact forces are partly absorbed by said material and partly transferred to the wall section 612 of the intermediate module 610 towards the luggage device.

Preferably, the basic module is mounted to the intermediate module with play to absorb external impact forces. Further, a shock absorbing module can be provided carrying the basic module.

FIG. 10 shows an exploded view of the electronic token shown in FIG. 9. The sandwich layer includes, from top to bottom, the shock absorbing module 620 provided with an opening 622 at least partly traversed by a button 670, a bottom spacer 660 and a top spacer 661, a first optical bonding layer 630, the basic module 600 including a display, a second bonding layer 652, the reinforcement PCB layer 651, the double sided tape 653 and the PCB layer 650 including a battery 680. The shock absorbing module 620 of the sandwich layer is carried by the wall section 612 of the intermediate module 610, such that the basic module 600 has some play towards the floor section 611 and, preferably, also to the wall section 612 of the intermediate module 610. The intermediate module 610 may be attached to a luggage device using a double side tape 690 or another adhesive material.

The invention is not restricted to the embodiments described herein. It will be understood that many variants are possible.

As an example, the software services platform may transmit the encrypted flight data such as travel documents to the electronic token without notifying the user of the mobile electronic device.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. A method of transmitting data from a software services platform to an electronic token, comprising the steps of:
pushing or pulling encrypted data from the platform via the Internet to a mobile electronic device;
providing a short range wireless communication channel between the mobile electronic device and the electronic token, and
forwarding the encrypted data from the mobile electronic device towards the electronic token.

2. A method according to claim 1, further comprising the step of performing an authentication process between the platform and the electronic token, via the Internet, the mobile electronic device and the short range wireless communication channel.

3. A method according to claim 2, wherein the step of pushing or pulling the encrypted data to the mobile electronic device and/or the step of forwarding the encrypted data towards the electronic token is only performed if the authentication process has a positive result.

4. A method according to claim 2, wherein the encrypted data on the mobile electronic device or electronic token is deleted if the authentication process has a negative result.

5. A method according to claim 1, further comprising a step of decrypting the encrypted data on the electronic token.

6. A method according to claim 5, wherein the decrypting process on the digital token is performed using a private key.

7. A method according to claim 1, wherein the platform further transmits user interface information to the mobile electronic device.

8. A method according to claim 1, wherein the encrypted data include boarding pass image data and/or electronic bag tag image data.

9. A method according to claim 1, wherein the short range wireless communication channel is based on a NFC, BT, BLE, RFID UHF or similar technology.

10. A mobile electronic device having Internet connectivity, the device comprising a processor that is arranged for:
receiving encrypted data from a software services platform;
providing a short range wireless communication channel between the mobile electronic device and an electronic token, and
forwarding the encrypted data from the mobile electronic device towards the electronic token.

11. A mobile electronic device according to claim 10, implemented as a smartphone, a tablet or other portable device.

12. An electronic token, comprising a processor that is arranged for:
supporting a short range wireless communication channel with a mobile electronic device that has received encrypted data from a software services platform, and
receiving the encrypted data from the mobile electronic device.

13. An electronic token according to claim 12, further comprising a secure element for decrypting the encrypted data.

14. An electronic token according to claim 13, wherein the secure element comprises a private hardware key or a decryption controller.

15. An electronic token according to claim 12, further comprising a display for displaying boarding pass data and/or electronic bag tag data, from the encrypted data received from the mobile electronic device.

16. An electronic token according to claim 15, wherein the display includes an E-paper display.

17. An electronic token according to claim 12, implemented as a bag tag or a smartcard.

18. An electronic token according to claim 15, being permanently or semi-permanently mounted to a luggage device.

19. An electronic token according to claim 18, comprising a basic module and a removable intermediate module that is connectable to the luggage device.

20. An electronic token according to claim 18, being mounted in a cavity of the luggage device.

21. An electronic token according to claim 18, being mounted at a side of the luggage device that is provided with a handle.

22. An electronic token according to claim 19, wherein the basic module is mounted to the intermediate module with play.

23. An electronic token according to claim 19, further comprising a shock absorbing module carrying the basic module.

24. An electronic token according to claim 12, further comprising a localization system and/or a transmitter for transmitting data to a further wireless communication channel.

25. An electronic token according to claim 12, further comprising a user interface for receiving user-specific data.

26. A software services platform, comprising a database including encrypted data, and a processor for pushing or pulling encrypted data from the platform via the Internet to a mobile electronic device.

27. A software services platform according to claim 26, further comprising an electronic token database including a list of electronic tokens, wherein each of the electronic tokens is associated with a private key and authentication data.

28. A computer program product for transmitting data from a software services platform to an electronic token, the computer program product comprising computer readable code for causing a processor on the platform, a processor on a mobile electronic device having Internet connectivity and/or a processor on the electronic token to facilitate a process including the steps of:
pushing or pulling encrypted data from the platform via the Internet to the mobile electronic device;
providing a short range wireless communication channel between the mobile electronic device and the electronic token, and
forwarding the encrypted data from the mobile electronic device towards the electronic token.
